(19) United States
(12) Patent Application Publication
(10) Pub. No.: US 2008/0265697 A1
(43) Pub. Date: Oct. 30, 2008

(54) Electrical Machine, in Particular Rotary Current Generator

(76) Inventors: Hubert Bischof, Vaihingen/Enz (DE); Gert Wolf, Affalterbach (DE); Guenter Rademacher, Filderstadt-Harthausen (DE)

Correspondence Address: MICHAEL J. STRIKER, 103 EAST NECK ROAD, HUNTINGTON, NY, 11743, US

(21) Appl. No.: 12/088,739

(22) PCT Filed: Sep. 15, 2006
(86) PCT No.: PCT/EP2006/066395

§ 371 Date: May 28, 2008

(30) Foreign Application Priority Data
Sep. 30, 2005 (DE) 102005048096.9

(51) Int. Cl. H02K 5/24

(52) U.S. Cl. 310/51

(57) ABSTRACT

The invention relates to an electrical machine, in particular a three-phase alternator (10), having a claw-pole rotor (11) with direct-current excitation, and having a stator winding (16) which is inserted into the slots in a laminated stator core and comprises a plurality of winding systems (16A, 16B), each having three winding sections (R, Y, B) connected to form a star circuit, with the winding systems each being offset through 120° electrical with respect to one another, and with the winding systems also being offset through an electrical angle ε with respect to one another. In order to damp mechanically caused noise in the generator when the machine is used in motor vehicles, it is proposed that the three-phase winding systems (16A, 16B) be connected to one another at their start points (P1, P2) via a coupling element 30 (20).

### PRIOR ART

The invention relates to an electrical machine, in particular to a rotary current generator with a direct-current-excited rotor, as generically defined by the preamble to claim 1.

In rotary current generators for motor vehicles, electrical machines with a direct-current-excited claw pole rotor are predominantly employed, to enable adequately supplying the direct current on-board electrical system of each motor vehicle even in the idling range of the drive motor. Besides numerous other demands made of the generator, the so-called magnet noise of the generator must be damped. For that purpose, it is known to make a chamfer on the trailing edge of the claw pole prong of the rotor; this chamfer distributes the breakdown of the magnetic field at the edges of the claws over a larger surface area of the claws and thus damps the magnetically induced vibration noises at the machine. This provision, however, means a power reduction in the lower rpm range. To attain a defined power level, larger and heavier generators must therefore be used. In addition, two different type part numbers per rotor are needed for the claw prongs, and the magnet noise is moreover dependent on the size and shape of the end plates of the generator.

It is also known, for suppressing the magnet noise at the stator winding of the generator, to distribute the individual winding phases in such a way that they are partly inserted into the respective adjacent slots. However, these provisions reduce the power output of the generator and increase its losses. This in turn increases the structural size or the weight-to-power ratio of the generator for a predetermined power output. Because of the voltage waviness of the direct current that is output, noise from vibration can moreover occur in the cable strands of the vehicles, in certain rpm ranges of the drive motor.

It is also known to equip the rotary current generator with six-phase system, in order to double the frequency of the rectification and thus reduce the voltage waviness of the direct current that is delivered via a rectifier unit to an accumulator of the on-board vehicle electrical system. From European Patent Disclosure EP 1 120 881 A2 (FIG. 6), it is known to embody the stator winding of a rotary current generator in the form of two winding systems, each with three winding phases connected in a Y-connection with one another. The winding phases in the Y-connection are offset electrically by 120° each from one another. The two winding systems are offset from one another electrically by approximately 30°. The magnet noise of the machine that then occurs, however, is damped only inadequately.

With the present solution to this problem, the goal, in an electrical machine with an at least six-phase stator winding, is to reduce the magnetically induced noise markedly, without sacrificing power.

### ADVANTAGES OF THE INVENTION

The machine of the invention having the definitive characteristics of claim 1 has the advantage that with the coupling element, the voltage waviness of the voltage of the rotary current output by the rotary current generator and of the direct current delivered to the on-board vehicle electrical system is reduced, and the magnetically caused noise at the electrical machine and in the on-board electrical system of the vehicle is largely suppressed.

It is considered to be a further advantage that particularly in high-power generators in the high rpm range, the mechanical loads and the power loss of the generator are also reduced by halving the voltage waviness. Moreover, such damping of the magnet noise can be achieved regardless of the application of such generator components as end plates and rotors.

By the provisions recited in the dependent claims, expedient embodiments and refinements of the characteristics recited in claim 1 are obtained.

Especially effective damping of the magnetically caused noise is obtained, in a six-phase stator winding, when the two winding systems, connected to one another at their neutral points via the coupling element, are offset electrically from one another by an electrical angle ε of 20° to 40°, preferably by a slot pitch of the stator lamination packet of 30°. Since between the neutral points of the two three-phase winding systems, the third harmonic of the fundamental oscillation of the rotary current system occurs especially markedly, the damping of this third harmonic is of particular significance. For damping this third harmonic, it is proposed that the coupling element have a resistor, preferably a complex resistor, with a more or less major ohmic, inductive, and/or capacitive component. The ohmic resistance is expediently between 5Ω and 1000Ω. Since the magnetically caused noises are also temperature- and voltage-dependent, it is proposed that the coupling element have a resistance that is dependent on the temperature and/or the voltage.

To attain a desired damping characteristic, it is equally possible for the coupling element to have a semiconductor, preferably a bidirectional semiconductor, with diode, Z diode, and/or transistor components. It can furthermore be expedient for the coupling element to have a combination of semiconductor components and at least one resistor.

The coupling element should preferably be mounted in the winding head of the stator winding; then advantageously at least one terminal and preferably both terminals of the coupling element should be embodied as a pickup for a measurement signal. In the simplest case, the pickup of the coupling element that carries a voltage signal of the third harmonic of the fundamental of the three-phase winding system is connected to a signal input of a regulator. In a refinement of the invention, it is moreover possible for the pickup of the coupling element to be connected to an evaluation circuit for determining the machine rpm and/or for measuring the utilization of the machine.

### DRAWINGS

The invention will be described in further detail below in examples in conjunction with the drawings. Shown are:

FIG. 1, the circuit diagram of a rotary current generator of the invention for motor vehicles, with an on-board electrical system connected to it;

FIG. 2, a fragment of the generator with the stator winding in cross section;

FIG. 3 shows the circuit diagram of the two winding systems of the generator with the coupling element and a regulator connected to it;

FIG. 4 shows alternative embodiments a) through g) of the coupling element; and

FIG. 5 shows a coupling element connected to an evaluation circuit;

FIG. 6 shows a noise level graph of the machine for various resistances of the coupling element; and

FIG. 7 shows a noise level graph of the machine with and without the coupling element.

### DESCRIPTION OF THE EXEMPLARY EMBODIMENTS

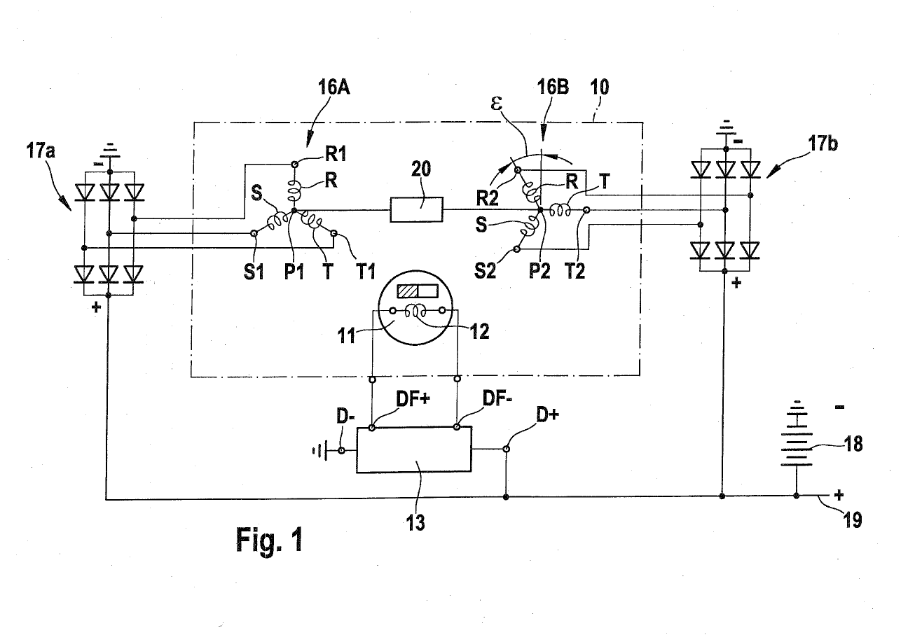

In FIG. 1, a rotary current generator for motor vehicles, as an electrical machine according to the invention, is shown in a circuit diagram and marked 10. The rotary current generator has a claw pole rotor 11, whose exciter winding 12 is supplied with direct current in a known manner via a regulator 13. The claw pole rotor 11 is supported in two end plates, not shown, of the machine, between which a stator lamination packet is clamped in place.

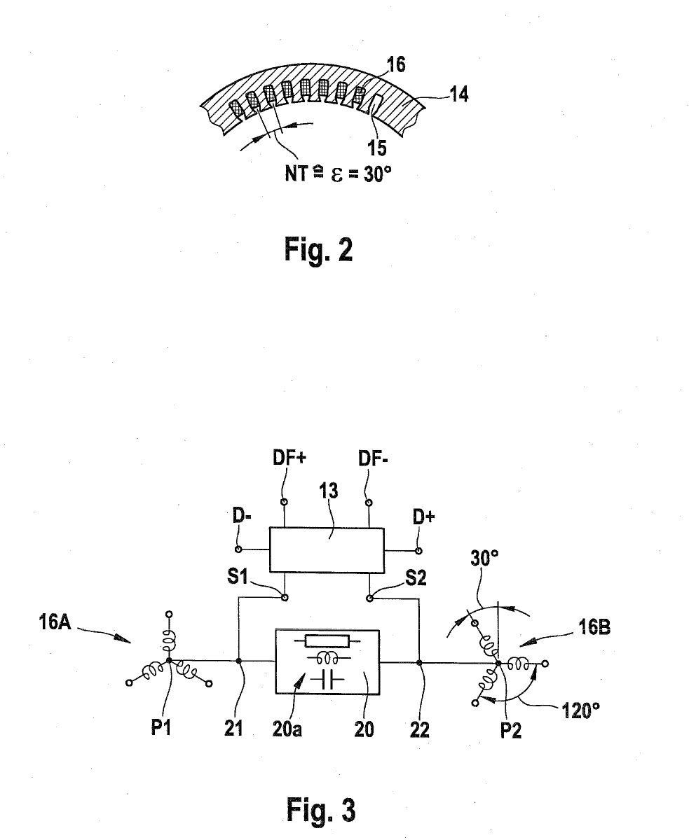

FIG. 2 shows a fragment of the stator lamination packet 14, with a stator winding 16 inserted into the slots 15 of the lamination packet. It can be seen from FIG. 1 that in this example, the stator winding 16 comprises two winding systems 16A, 16B, which each have three winding phases R, S, T and which are each connected to one another to form a Y-connection. The thus-formed three phases of the two winding systems 16A, 16B are offset electrically from one another—as usual—by 120° each. The two winding systems 16A, 16B are offset from one another by an electrical angle ε, which in this example is 30°. In a stator lamination packet 14 having a total of 96 slots 15, with eight pole pairs, this angle results from a slot pitch NT as in FIG. 2, in that the coils of the winding phases of one winding system 16A are inserted into the adjacent slots to the coils of the other winding system 16B. It can also be seen from FIG. 1 that the phase terminals R1, S1, T1 of the winding system 16A are connected to one bridge rectifier 17a, and the phase terminals R2, S2 and T2 of the other winding system 16B are connected to another bridge rectifier 17b. The two bridge rectifiers 17a, 17b form a rectifier unit, not shown, which is typically located on the rear end plate of the rotary current generator 10. The negative pole of the bridge rectifiers 17a and 17b, like the negative pole of an accumulator battery 18 of the on-board vehicle electrical system 19, is connected to ground. The positive pole of the bridge rectifiers 17a, 17b is connected to the positive pole of the accumulator battery 18 and consequently to the positive pole of the on-board vehicle electrical system 19. The voltage of the on-board vehicle electrical system 19 is carried via a D+ terminal to the regulator 13.

The rotary current generator 10 is driven in a manner not shown by the drive motor of the motor vehicle, and the voltages induced in the winding systems 16A and 16B are rpm-dependent in their frequency and level. They are moreover regulated, depending on the load on the on-board vehicle electrical system 19 and the load state of the accumulator battery 18, by the exciter current, regulated by the regulator 13, in the exciter winding 12. Because of the angle ε by which the two winding systems 16A and 16B are offset from one another, potential differences occur between the two neutral points P1 and P2, and these differences oscillate in particular at the third harmonic of the fundamental of the winding systems and both at the generator and in the on-board electrical system can cause magnetically dictated noise. For damping this interfering noise development, it is now provided according to the invention that the two neutral points P1 and P2 are connected to one another via a coupling element 20. The coupling element 20 is expediently placed, jointly with the two neutral points P1 and P2 of the two winding systems 16A and 16B, in a winding head of the stator winding 16. Alternatively, it is equally possible for the beginning and end of the winding phases R, S and T to be extended out of the generator, for instance to the bridge rectifiers 17a and 17b, and to form the neutral points P1 and P2 there and connect them to one another there via the coupling element 20.

FIG. 3 again shows the circuit of the two three-phase Y-connections 16A and 16B of the stator winding 16, whose neutral points P1 and P2 are connected to one another via the coupling element 20. It can also be seen here that the terminals of the coupling element 20 are embodied as pickups 21 and 22 for a measurement signal. Since the voltage signal at the coupling element 20 oscillates at three times the frequency of the fundamental signal, this signal is delivered via the pickups 21 and 22 to a respective input S1 and S2 of the regulator 13, which typically is likewise located on the face end of the rear end plate of the machine. Since this signal, in certain rpm ranges, can exceed the magnitude of the fundamental signal, it is possible by means of a suitable characteristic curve of the regulator and with the aid of this voltage signal to vary the regulation of the output voltage of the generator. It can also be seen from FIG. 3 that the coupling element 20 has a complex resistor 20a with a more or less great ohmic, inductive and/or capacitive component.

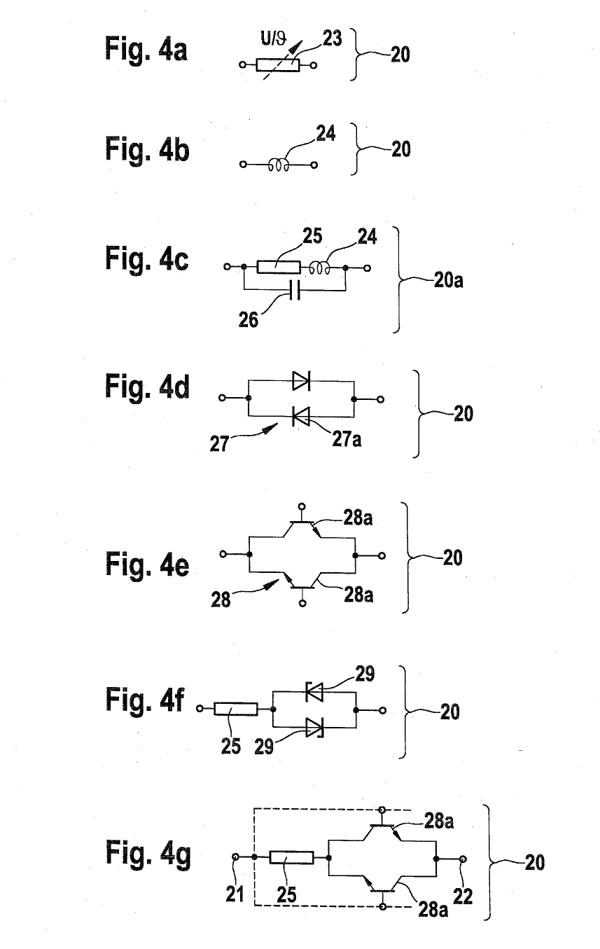

In FIG. 4, a) through g) represent some of the various possible embodiments in the design of the coupling element 20 as a circuit. In the example 4a), the coupling element selectively has a purely ohmic, a voltage-dependent, and/or a temperature-dependent resistor 23. The temperature-dependent resistor 23 is expediently embodied as a PTC resistor. A varistor is preferably used as the voltage-dependent resistor of the coupling element 20. In example 4b), the coupling element 20 essentially has a coil 24 as its inductive resistor. In example 4c), the coupling element 20 comprises a plurality of components, and an ohmic resistor 25 is connected to the input side of the coil 24. Parallel to this series circuit, there is also a capacitor 26, as a capacitive resistor. This all accordingly forms a complex resistor 20a as in FIG. 3. In example 4d), the coupling element 20 has a bidirectional semiconductor 27 in the form of two diodes 27a connected antiparallel to one another. In example 4e), the coupling element 20 comprises a bidirectional transistor 28 with two antiparallel-connected transistor elements 28a. In example 4f, the coupling element 20 comprises two antiparallel-connected Z diodes 29, with which the resistor 25 is connected in series. In example 4g), the resistor 25 is connected in series with the two bidirectional transistors 28a, and optionally the base of the transistors 28a is connected to the pickup end of the resistor 25—as indicated in dashed lines. Hence the semiconductor arrangement of the transistors 28a can be made more or less conducting as a function of the amplitude of the third harmonic at the pickups 21, 22 of the coupling element 20 for damping purposes. It is understood that in the embodiment of the coupling element 20, numerous further circuitry combinations of various components can also be implemented.

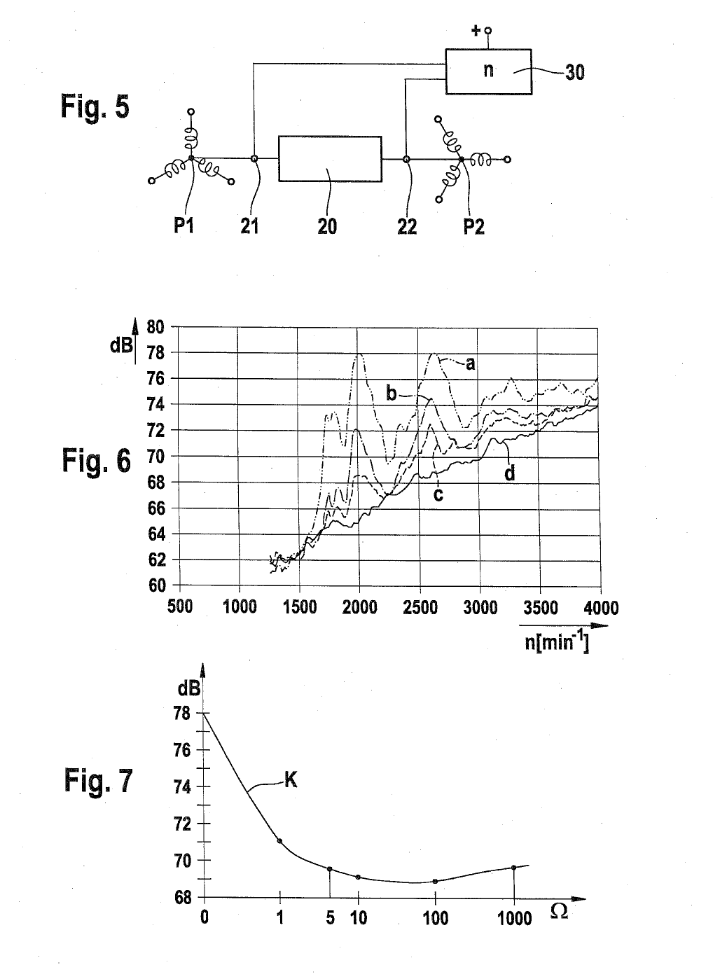

In FIG. 5, once again, the coupling element 20 is shown between the two neutral points P1 and P2, with its pickups 21 and 22. These pickups 21 and 22 are connected here to the inputs of an evaluation circuit 30. Since over the entire rpm range of the drive motor, the voltage signal picked up here, with the third harmonic, represents a high-frequency rpm signal, it is possible in this way, in the evaluation circuit 30, to ascertain the machine rpm n with high precision.

In the simplest case, for damping the third harmonic of the fundamental signal, the coupling element 20 is equipped with a purely ohmic resistor, which depending on its type has a resistance between 5Ω and 1000Ω. FIG. 6 shows how with various ohmic resistors at the coupling element 20, the sound pressure level in dB can be damped as a function of rpm. At a resistance of 0Ω, that is, a short circuit between the neutral points P1 and P2, a sound level of up to 78 dB occurs in the speed range between 1500 and 3000 rpm in accordance with characteristic curve a. At a resistance of 0.5Ω, the sound level is already markedly less, as shown in characteristic curve b, at a maximum of 75 dB at approximately 2500 rpm. At a resistance of 1.0Ω, as shown in characteristic curve c, a further reduction in the sound level over the entire rpm range occurs, with a peak of 73 dB at approximately 2500 rpm. Finally, in the specified exemplary embodiment, at a resistance of 10Ω, optimal damping occurs, as represented by the characteristic curve d. The noise level that now remains, which rises virtually linearly with the rpm, is essentially due to generator bearing and air flow noise.

The inventive solution to the stated problem is not limited to the exemplary embodiments shown and described. For instance, it is equally possible, instead of a six-phase winding system, to embody the stator winding of the generator as a nine- or twelve-phase winding system and to combine it into three or four neutral point circuits. The neutral points must always be connected to one another via a coupling element 20 whenever the Y-connections are offset from one another by an electrical angle ε.

It is also possible within the scope of the invention for the measurement signal for the regulator 13 of FIG. 3 or for the evaluation circuit 30 of FIG. 5 to be picked up only at one of the two pickups 21 and 22, by connecting the other input to ground. The measurement signal to be evaluated is then ascertained compared to ground. The magnetically caused noise level is damped because of a compensatory current between the two rotary current systems via the coupling element 20, or in other words is markedly reduced compared to the noise level when the neutral points are separate from one another. It does not matter whether the compensatory current flows via capacitive, inductive, or ohmic components, or via semiconductor paths.

In FIG. 7, the noise level of the machine is represented as a function of the resistance of the coupling element as a characteristic curve K that has been ascertained over a mean speed range of 1500 to 300 rpm. Measurements have shown that at ohmic resistors with resistances of >1 kΩ, the magnetically induced noise level of the machine increases again, so that an optimal damping range is found with an ohmic resistor of between 5Ω and 1 kΩ.

1. An electrical machine, in particular a rotary current generator (10), having a direct-current-excited rotor, in particular a claw pole rotor (11), and a stator winding (16), inserted into the slots (15) of a stator lamination packet (14), which stator winding comprises a plurality of three-phase winding systems, in particular two of them, each with three winding phases (R, S, T) connected in a Y-connection, the winding phases being offset electrically from one another by 120° each, and the winding systems are offset from one another by an electrical angle (ε), characterized in that the three-phase winding systems (16A, 16B) are connected to one another at their neutral points (P1, P2) via a coupling element (20).

2. The electrical machine as defined by claim 1, characterized in that the winding systems (16A, 16B) are offset electrically from one another by an electrical angle (ε) of between 20° and 40°, preferably by a slot pitch (NT) of the stator lamination packet of 30°.

3. The electrical machine as defined by claim 2, characterized in that the coupling element (20), located in the generator (10), preferably in the winding head of the stator winding (16), has a resistor (23, 25), preferably a complex resistor (20a) with a more or less great ohmic, inductive and/or capacitive component.

4. The electrical machine as defined by claim 3, characterized in that the coupling element (20) has an ohmic resistor (25) in the range from 5Ω to 1000 Ω.

5. The electrical machine as defined by claim 3, characterized in that the coupling element (20) has a resistor (23) that is dependent on the temperature and/or the voltage.

6. The electrical machine as defined by claim 1, characterized in that the coupling element (20) has a semiconductor, preferably a bidirectional semiconductor (27) with diodes (27a), Z diodes (29), and/or transistor elements (28a).

7. The electrical machine as defined by claim 3, characterized in that the coupling element (20) has a combination of semiconductor components (27, 28, 29) and at least one resistor (25).

8. The electrical machine as defined by claim 1, characterized in that at least one terminal and preferably both terminals of the coupling element (20) are embodied as a pickup (21, 22) for a measurement signal.

9. The electrical machine as defined by claim 8, characterized in that the pickup (21, 22) of the coupling element (20) is connected to at least one signal input (S1, S2) of a regulator (13) of the machine and carries a voltage signal of the third harmonic of the fundamental of the three-phase winding systems (16A, 16B).

10. The electrical machine as defined by claim 1, characterized in that the pickup (21, 22) of the coupling element (20) is connected to an evaluation circuit (30) for measuring the rpm and/or the utilization of the machine.
